(19) United States
(12) Patent Application Publication
(10) Pub. No.: US 2025/0073645 A1
(43) Pub. Date: Mar. 6, 2025

(54) PENTA-AMINE-IMPREGNATED ULTRAFILTRATION SUPPORT MATRIX FOR RAPID FABRICATION OF A HYPER-CROSS-LINKED POLYAMIDE MEMBRANE

(71) Applicant: KING FAHD UNIVERSITY OF PETROLEUM AND MINERALS, Dhahran (SA)

(72) Inventors: Abdul WAHEED, Dhahran (SA); Umair BAIG, Dhahran (SA)

(73) Assignee: KING FAHD UNIVERSITY OF PETROLEUM AND MINERALS, Dhahran (SA)

(21) Appl. No.: 18/460,101

(22) Filed: Sep. 1, 2023

(51) Int. Cl. B01D 69/12; B01D 67/00; B01D 69/04; B01D 71/56

(52) U.S. Cl. CPC B01D 69/1214; B01D 67/0006; B01D 69/043; B01D 69/1216; B01D 71/56

(57) ABSTRACT

The present disclosure provides a filtration membrane. The filtration membrane includes a thermoplastic substrate, a first layer comprising a polysulfone, a polyvinylpyrrolidone, and a pentaamine, and a second layer comprising the pentaamine and reacted units of a phthaloyl chloride cross-linked to form a polyamide. A method of preparing the filtration membrane by impregnating pentaamine in an ultrafiltration support matrix for rapidly fabricating a hyper-cross-linked polyamide membrane is also disclosed. The membrane prepared by the method of present disclosure can be used for organic solvent nanofiltration (OSN).

### STATEMENT REGARDING PRIOR DISCLOSURE BY THE INVENTORS

Aspects of the present disclosure were disclosed in an article titled “Exploiting phase inversion for penta-amine impregnation of ultrafiltration support matrix for rapid fabrication of a hyper-cross-linked polyamide membrane for organic solvent nanofiltration” published in Volume 169, Process Safety and Environmental Protection, which is incorporated herein by reference in its entirety.

### STATEMENT OF ACKNOWLEDGEMENT

The support provided by the Interdisciplinary Research Center for Membranes and Water Security, King Fahd University of Petroleum and Minerals, Saudi Arabia, through project INMW2213 is gratefully acknowledged.

### BACKGROUND

### Technical Field

The present disclosure relates to membranes, and more particularly, relates to a penta-amine-impregnated ultrafiltration support matrix for the rapid fabrication of a hyper-cross-linked polyamide membrane.

### Discussion of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

One of the major challenges faced by the pharmaceutical industry is organic solvent waste. 80% of the waste generated in pharmaceutical companies consists of organic solvents. Such organic solvents are needed in large quantities for the separation and purification of active pharmaceutical ingredients (API); hence, recovering organic solvents can cover up to 80% of the capital cost in such industries. The need to develop efficient, cost-effective technologies with a lesser footprint for the recovery and purification of organic solvents exists. Among a multitude of technologies available for recovering organic solvents, membrane-based separation is advantageous due to its low operation and capital cost, ease of handling, smaller carbon footprint, and ease of tunability. The development of efficient membranes for organic solvent nanofiltration (OSN) is an area to explore for a better future of industrial development.

Polyamide thin film composite (PA-TFC) membranes are evolving and have a potential for different applications such as desalination, water treatment, and organic solvent nanofiltration (OSN). Generally, PA-TFC membranes are fabricated by interfacial polymerization (IP), in which a reaction takes place at an interface between an aqueous solution of an amine (for example, meta-phenylenediamine (MPD)) and non-aqueous solution of a crosslinker, such as trimesoyl chloride (TMC). Conventionally, PA-TFC membranes are fabricated by following two steps. The first step is the fabrication of an ultrafiltration support, such as polyacrylonitrile (PAN), polysulfone (PSU), and/or polyether sulfone (PESf), through dry or wet phase inversion. During phase inversion, the polymer dope solution is cast on a non-woven fabric, such as polyester terephthalate (PET), which is subsequently dipped in a non-solvent coagulation bath. The dipping in the non-solvent coagulation bath leads to the inversion of polymer from liquid to solid phase, which leads to the ultrafiltration support. After phase inversion is the second step of PA-TFC membrane fabrication, in which the ultrafiltration support is dipped simultaneously in deionized (DI) water and sodium dodecyl sulfate (SDS) solution for 24 hours each, and then the ultrafiltration support is impregnated by dipping the support in aqueous amine solution. Afterward, an amine-impregnated ultrafiltration support is dipped in another solution of an appropriate crosslinker, such as TMC. Advances have been made for fabricating a variety of membranes by adopting a traditional two-step IP process. Efforts have been focused on improving the membrane performance by altering the chemistry of the active layer of the membrane. Various additives such as nanoparticles, covalent organic frameworks (COFs), and metal-organic frameworks (MOFs) have been incorporated in either active layer or ultrafiltration support of the membranes. In addition, a variety of interlayers has also been explored in order to develop membranes with desired surface geometries and performance [J. E. Gu, J. S. Lee, S. H. Park, I. T. Kim, E. P. Chan, Y. N. Kwon, J. H. Lee, Tailoring interlayer structure of molecular layer-by-layer assembled polyamide membranes for high separation performance, Appl Surf Sci. 356 (2015) 659-667, incorporated herein by reference in its entirety]. Less attention has been directed to improving the procedure of membrane fabrication, which may lead to better membranes with less effort and resources.

A relatively less explored and robust methodology has been explored for fabricating crosslinked PA-TFC membranes, which is simple and rapid compared to conventional IP process [S. Hermans, H. Marien, E. Dom, R. Bernstein, I. F. J. Vankelecom, Simplified synthesis route for interfacially polymerized polyamide membranes, J Memb Sci. 451 (2014) 148-156, incorporated herein by reference in its entirety]. This simplified strategy combines phase inversion and amine impregnation in a single step, which not only lowers the required efforts but also decreases the time required (4 hours in the mentioned study) for the two separate steps (24 hours are generally required). In this method, amine was added into a coagulation bath and phase inversion was carried out in the aqueous amine coagulation bath. The amine was impregnated in the polymeric matrix of the ultrafiltration support and in the walls of micropores of ultrafiltration support. Unlike the conventional IP process, where the wet PSU support is dipped in an aqueous solution and IP is carried out on the PSU surface, the modified method of phase inversion of the present disclosure takes place in the presence of an amine in an aqueous bath where the amine gets embedded in a polymeric matrix. Upon exposure to a crosslinker (TMC) solution, a reaction takes place between amine and TMC, leading to the formation of a polyamide active layer on ultrafiltration support. The polyamide active layer is grown from within the matrix of the PSU and the micropores of the support are also lined with the polyamide active layer. In addition to the simplification of the membrane fabrication process, the approach of the present disclosure also develops a considerable interaction between the active layer and PSU support. These features lead to a PA-TFC membrane with an improved performance in terms of rejection and permeate flux. The simplified approach of membrane fabrication has been previously used in fabricating PA-TFC membranes for desalination. The current approach has not been explored for fabricating a PA-TFC membrane for the organic solvent nanofiltration (OSN).

Accordingly, an object of the present disclosure is to provide a filtration membrane by functionalizing and hyper-cross-linking the components of active layers in the membrane to enhance selectivity. The membrane prepared by this method obviates the drawbacks associated with conventional methods, which are generally complex and require long synthesis periods and multiple steps for membrane fabrication.

### SUMMARY

In an exemplary embodiment of the present disclosure, a filtration membrane is disclosed. The filtration membrane includes a thermoplastic substrate, a first layer comprising a polysulfone, a polyvinylpyrrolidone, and a pentaamine, and a second layer comprising the pentaamine and reacted units of a phthaloyl chloride cross-linked to form a polyamide.

In some embodiments, the pentaamine in the first layer is physically adsorbed in the polysulfone and the polyvinylpyrrolidone.

In some embodiments, the pentaamine in the second layer is covalently cross-linked with units of the phthaloyl chloride through at least one of a primary amine group and a secondary amine group of a first pentaamine and at least one of a primary amine group and a secondary amine group of a second pentaamine.

In some embodiments, the second layer comprises the polyamide in a hyper-branched cross-linked matrix.

In some embodiments, the pentaamine is a tetraethylenepentamine.

In some embodiments, the second layer is in the form of nanoparticles with a diameter of 10 to 500 nanometers (nm).

In some embodiments, the first layer is in the form of vertical hollow tubes having a diameter of 0.5 to 10 micrometers (μm) and a length of 5 to 50 μm.

In some embodiments, the second layer covers the vertical hollow tubes of the first layer.

In some embodiments, the second layer has a thickness of 0.5 to 5 μm.

In some embodiments, a water contact angle is from 75 to 85°.

In some embodiments, a carbon in an amount of 75 to 78% by weight, oxygen in an amount of 14 to 17% by weight, sulfur in an amount of 4 to 7% by weight, and nitrogen in an amount of 1 to 4% by weight based on a total weight of the membrane.

In some embodiments, a surface roughness is from 24 to 27 nm.

In an exemplary embodiment, a method of making the filtration membrane is described. The filtration membrane includes dissolving the polysulfone and the polyvinylpyrrolidone in a solvent to form a solution; fixing the thermoplastic substrate on a glass surface; spreading the solution on the thermoplastic substrate fixed on the glass surface to form a support; dipping the support in an aqueous solution of the tetraethylenepentamine to adsorb the tetraethylenepentamine to the support and form the first layer; contacting the first layer with an organic solution of the phthaloyl chloride to form the polyamide; and heating to from the filtration membrane.

In some embodiments, the membrane has a rate of flux of methanol of 5 to 7 L m⁻² h⁻¹ at a pressure of 4 bar.

In some embodiments, the membrane has a rate of flux of methanol of 25 to 30 L m⁻² h⁻¹ at a pressure of 20 bar.

In an exemplary embodiment, a method of nanofiltration is described. The method includes passing a composition through the filtration membrane, wherein the composition comprises at least solvents and solutes, and collecting a permeate passing through the filtration membrane to obtain a purified composition having a reduced amount of solutes.

In some embodiments, the membrane has a rejection profile of solutes from 85 to 100% by weight in methanol.

In some embodiments, the solutes are Congo Red, Eriochrome Black T, and Methylene Blue.

In some embodiments, the solvents are water, methanol, ethanol, and isopropanol.

In some embodiments, when the solvent is methanol and the solute is Congo Red, the membrane has a rejection profile from 95 to 100% by weight.

These and other aspects of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A better understanding of embodiments of the present disclosure (including alternatives and/or variations thereof) may be obtained with reference to the detailed description of the embodiments along with the following drawings, in which:

FIG. 1 is a flowchart depicting a method of making a membrane, according to an aspect of the present disclosure;

FIG. 2 is a schematic illustration depicting various stages of fabrication of polyamide (tetraethylenepentamine-terephthaloyl chloride) (@polysulfone/polyesterterephthalate, also referred to as “PA (TEPA-TCL)@PSU/PETP” membrane, according to an aspect of the present disclosure:

FIG. 3A depicts a proposed structure of an active layer of the PA (TEPA-TCL)@PSU/PETP membrane formed during interfacial polymerization (IP) reaction between tetraethylenepentamine (TEPA) and terephthaloyl chloride (TCL), according to certain embodiments:

FIG. 3B depicts attenuated total reflectance Fourier ransform nfrared (ATR-FTIR) spectroscopy of polysulfone (PSU), polysulfone/polyesterterephthalate (PSU/PETP) support, and PA (TEPA-TCL)@PSU/PETP membrane, according to certain embodiments:

FIG. 3C depicts ATR-FTIR spectroscopy of a fingerprint region of polysulfone (PSU), polysulfone/polyesterterephthalate (PSU/PETP) support, and PA (TEPA-TCL)@PSU/PETP membrane, according to certain embodiments:

FIGS. 4A and 4B show micrographs of the PSU/PETP support, at different magnifications, according to certain embodiments:

FIGS. 4C and 4D show micrographs of the PA (TEPA-TCL)@PSU/PETP membrane, according to certain embodiments:

FIG. 4E shows the water contact angle (WCA) of the PSU/PETP support and the PA (TEPA-TCL)@PSU/PETP membrane, according to certain embodiments:

FIGS. 5A and 5B show cross-sectional micrographs of the PSU/PETP support, at different magnifications, according to certain embodiments:

FIGS. 5C and 5D show cross-sectional micrographs of the PA (TEPA-TCL)@PSU/PETP membrane, at different magnifications, according to certain embodiments:

FIG. 6A shows an energy dispersive X-ray (EDX) spectroscopic analysis of the PA (TEPA-TCL)@PSU/PETP membrane, according to certain embodiments:

FIG. 6B shows an elemental map of carbon in the PA (TEPA-TCL)@PSU/PETP membrane, according to certain embodiments:

FIG. 6C shows an elemental map of sulfur in the PA (TEPA-TCL)@PSU/PETP membrane, according to certain embodiments:

FIG. 6D shows an elemental map of oxygen in the PA (TEPA-TCL)@PSU/PETP membrane, according to certain embodiments:

FIG. 6E shows an elemental map of nitrogen in the PA (TEPA-TCL)@PSU/PETP membrane, according to certain embodiments:

FIG. 7A shows two-dimensional (2D) atomic force microscopy (AFM) images of the PSU/PETP support, according to certain embodiments;

FIG. 7B shows a three-dimensional (3D) AFM image of the PSU/PETP support, according to certain embodiments:

FIG. 7C shows 2D AFM images of the PA (TEPA-TCL)@PSU/PETP membrane, according to certain embodiments:

FIG. 7D shows a 3D AFM image of the PA (TEPA-TCL)@PSU/PETP membrane, according to certain embodiments:

FIG. 8A shows effect of transmembrane pressure on permeate flux of different solvents by the PA (TEPA-TCL)@PSU/PETP membrane at 4 bar, according to certain embodiments;

FIG. 8B shows effect of solvent viscosity of permeate flux of different solvents by the PA (TEPA-TCL)@PSU/PETP membrane at 4 bar, according to certain embodiments;

FIG. 8C shows effect of dye size on permeate flux by the PA (TEPA-TCL)@PSU/PETP membrane at 4 bar, according to certain embodiments;

FIG. 8D shows rejection of dyes by the PA (TEPA-TCL)@PSU/PETP membrane at 4 bar while using methanol as a solvent, according to certain embodiments;

FIG. 9A shows 3D molecular structure of methylene blue (MB), according to certain embodiments;

FIG. 9B shows absorption spectra of feeds and permeates of the MB through the PA (TEPA-TCL)@PSU/PETP membrane at 4 bar while using methanol as a solvent, according to certain embodiments.

FIG. 9C shows 3D molecular structure of Eriochrome black T (EBT), according to certain embodiments;

FIG. 9D shows absorption spectra of feeds and permeates of the EBT through the PA (TEPA-TCL)@PSU/PETP membrane at 4 bar while using methanol as a solvent, according to certain embodiments:

FIG. 9E shows 3D molecular structure of Congo red (CR), according to certain embodiments; and

FIG. 9F shows absorption spectra of feeds and permeates of the CR through the PA (TEPA-TCL)@PSU/PETP membrane at 4 bar while using methanol as a solvent, according to certain embodiments

### DETAILED DESCRIPTION

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Wherever possible, corresponding, or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Furthermore, the terms “approximately,” “approximate,” “about,” and similar terms generally refer to ranges that include the identified value within a margin of 20%, 10%, or preferably 5%, and any values therebetween.

As used herein, the singular terms “a”, “an”, and “the” include plural referents, unless otherwise specified. Likewise, the plural term “multilayer” as used herein includes a singular referent comprising a monolithic or monolayer structure, unless specified otherwise.

As used herein, the term “membrane” refers to a porous structure that is capable of separating components of a homogeneous or heterogeneous fluid. Unless specified otherwise, the term “porous” as used herein refers to microporous, mesoporous, microporous, and combinations thereof. As used herein, the term “micropore” refers to a pore with a size ≤2 nm, the term “mesopore” refers to a pore size between 2 and 50 nm, and the term “macropore” refers to a pore with a size ≥50 nm. In particular, “pores” in the sense of the present disclosure indicate voids allowing fluid communication between different sides of the structure. More particular in use when a homogeneous or heterogeneous fluid is passed through the membrane, some components of the fluid can pass through the pores of the membrane into a “permeate stream”, some components of the fluid can be retained by the membrane and can thus accumulate in a “retentate”, and/or some components of the fluid can be rejected by the membrane into a “rejection stream”. Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon a reading of the present disclosure. Membranes can also be classified according to their pore diameter. Membranes can be neutral or charged. Particle transport can be active or passive, with the latter facilitated by pressure, concentration, chemical or electrical gradients of the membrane process, and the like.

Aspects of the present disclosure relate to a filtration membrane for organic solvent nanofiltration (OSN). The filtration membrane may be applied for oil-water separation, desalination, wastewater treatment, removal of micropollutants, and the like. In one example, the filtration membrane was fabricated by pentaamine (TEPA) impregnation of a polysulfone (PSU) matrix during phase inversion and reacted with terephthaloyl chloride (TCL) through interfacial polymerization (IP). The filtration membrane, also referred to as a PA (TEPA-TCL)@PSU/PETP membrane, was characterized by scanning electron microscopy (SEM), water contact angle (WCA), energy dispersive X-ray (EDX) analysis, attenuated total reflection Fourier transform infrared (ATR-FTIR) spectroscopy, surface roughness, and elemental mapping. The filtration membrane was further evaluated for OSN by using water, methanol, ethanol, and isopropanol as solvents. When methanol used as feed, the filtration membrane showed a permeate flux of 28 L m⁻² h⁻¹ (LMH) at 20 bar. An inverse relationship was found between viscosity and flux of the solvents. A feed composed of methanol and dyes (dyes were used as model pollutants) was used to evaluate the OSN performance of the filtration membrane. A size exclusion mechanism was found to influence rejection of dyes. The filtration membrane rejects the dyes in the following order: Erichrome black T (EBT) was rejected >92%, Congo red (CR) rejection reached >96%, and methylene blue (MB) was rejected ˜ 88%. UV-visible analysis of feed and permeate was conducted which indicated the rejection of EBT, CR, and MB. The PA (TEPA-TCL)@PSU/PETP membrane was found to be efficient for the purification of organic solvents containminated with organic dyes.

According to an aspect of the present disclosure, the filtration membrane, also referred to as a membrane, is described. The filtration membrane includes a thermoplastic substrate. The thermoplastic substrate may be porous in nature, allowing, in some aspects, liquid to permeate. The thermoplastic substrate may have pores of 1 to 1500 nm, preferably 5 to 1000 nm, more preferably 10 to 500 nm, and yet more preferably about 20 to 100 nm in diameter. In some embodiments, a first layer and a second layer covers at least 50%, preferably 60%, more preferably 80%, and yet more preferably more than 95% of the surface of the support. Generally, the thermoplastic substrate should possess good mechanical and thermal properties. The thermoplastic substrate should also demonstrate high resistance to chemicals such as aromatic hydrocarbons, ketones, ethers, and esters. The thermoplastic substrate is an aggregate material including a polymer component (thermoplastic polymer) configured to strengthen the membrane structure.

The thermoplastic substrate includes one or more thermoplastic polymers. Suitable examples of thermoplastic polymers include polypropylene (PP), polyamide (PA), polycarbonate (PC), high-density polyethylene (HDPE), low-density polyethylene (LDPE), polybutylene terephthalate (PBT), polyethylene terephthalate (PET), polystyrene (PS), polyether ether ketone (PEEK), polyphenylene sulfide (PPS), polyetherimide (PEI), polyamide-imide (PAI), acrylic (PAA), acrylonitrile butadiene styrene (ABS), polylactic acid (PLA), polyvinyl chloride (PVC), polyurethanes (PUR), polyvinylidene fluoride (PVDF), polytetrafluoroethylene (Teflon), the like, and/or a mixture thereof. In a preferred embodiment, the thermoplastic polymer includes PET, more specifically, unwoven polyester terephthalate (PETP).

In some embodiments, the thermoplastic substrate may comprise one or more layers of thermoplastic polymers. Each layer may be made of the same thermoplastic polymer or a different thermoplastic polymer. In some embodiments, blends of thermoplastic polymers may be used as well. The thermoplastic substrate may be of varying thickness. The thermoplastic substrate may have a thickness of 10 to 5000 μm, preferably 100 to 3000 μm, and more preferably 500 to 2000 μm.

In some embodiments, the thermoplastic substrate may be reinforced on a glass surface to impart greater mechanical/tensile strength to the membrane. In some embodiments, adhesives may be used to facilitate the fixing of one or more thermoplastic substrate to the surface. In an embodiment, the adhesive is a polyurethane adhesive. In certain other embodiments, the glass surface may optionally be surface activated by any of the methods conventionally known in the art, to facilitate the attachment of the thermoplastic substrate to the glass surface.

The membrane further includes a first layer including three components, namely a polysulfone, a polyvinylpyrrolidone, and a pentaamine. Polysulfones are a group of polymers, including a sulfone group and alkyl- or aryl-groups. The polysulfone polymer may be polysulfone (PSU), polyethersulfone (PES), polyphenylene sulfone (PPSU), poly(arylene sulfone) (PAS), poly(bisphenol-A sulfone) (PSF), or some derivative of polysulfone. The polysulfone polymer may also be called a polyaryl sulfone or a polyarylethersulfone. The polysulfone may be may be used alone or in combination with polymeric materials. Suitable polymers to be included in the first layer comprise, for example, polyvinylidene fluoride (PVDF), polytetrafluoroethylene (PTFE), polyacrylonitrile (PAN), poly(methyl methacrylate) (PMMA), poly(methacrylic acid) (PMAA), poly(acrylic acid) (PAA), poly(vinyl methyl ketone), poly(ether sulfone) (PSF), polyacrylonitrile (PAN), polypropylene (PP), polyimide (PI), and poly(arylene ether nitrile ketone) (PPENK), which can used alone or in combination with the polysulfone. In a preferred embodiment, the polysulfone polymer is polysulfone (PSU).

The first layer of the membrane further includes a second polymer of polyvinylpyrrolidone. In some embodiments, the first layer may further include copolymers of polyvinylpyrrolidone. Suitable examples of copolymers include vinylpyrrolidone/vinylacetate copolymers, vinylpyrrolidone/vinylalcohol copolymers, vinylpyrrolidone/styrene copolymers, vinylpyrrolidone/dimethylaminoethyl methacrylate copolymers, modified polymers thereof, or the like, which may be used alone or in combination with the polyvinylpyrrolidone.

In some embodiments, other polymers such as polyvinyl chloride, polyvinylidene chloride, polyacrylonitrile, high impact polystyrene, acrylonitrile butadiene styrene, polyethylene/acrylonitrile butadiene styrene, polycarbonate/acrylonitrile butadiene styrene, acrylic polymers, polybutadiene, polyisoprene, polyacetylene, silicones, synthetic rubbers and the like, and copolymers and mixtures thereof may be used as well instead of polyvinylpyrrolidone.

In one embodiment, the polysulfone polymer and the polyvinylpyrrolidone polymer each, independently, have a weight average molecular weight (MW) in a range of 2 to 3,000 kDa, preferably 5 to 2,000 kDa, preferably 10 to 1,000 kDa, preferably 10 to 800 kDa, preferably 15 to 500 kDa, and yet more preferably 20 to 100 kDa. In one embodiment, the polysulfone polymer has a weight average molecular weight (MW) in a range of 1 to 3,000 kDa, preferably 5 to 1,000 kDa, preferably 10 to 100 kDa, preferably 20 to 60 kDa, preferably 25 to 50 kDa, preferably 30 to 40 kDa, or more preferably about 35 kDa. In one embodiment, the polyvinylpyrrolidone polymer has a weight average molecular weight (MW) in a range of 1 to 3,000 kDa, preferably 2 to 1,000 kDa, preferably 4 to 100 kDa, preferably 5 to 40 kDa, preferably 6 to 20 kDa, preferably 8 to 12 kDa, or more preferably about 10 kDa.

The degree of polymerization (DP) is defined as the number of monomeric units in a macromolecule or polymer. In one embodiment, the polysulfone (PSU) polymer and the polyvinylpyrrolidone (PVP) polymer each, independently, have a degree of polymerization in the range of 100-2500, preferably 150-1500, preferably 200-750, and more preferably 250-500.

In one embodiment, a weight ratio of the polysulfone to the polyvinylpyrrolidone is 1:1 to 20:1, preferably 3:1 to 18:1, preferably 5:1 to 15:1, preferably 7:1 to 12:1, preferably 9:1 to 11:1, and more preferably about 9:1 The polysulfone and the polyvinylpyrrolidone together form the polymer matrix in the first layer of the membrane. The polysulfone and the polyvinylpyrrolidone may be dissolved in a polar solvent to form a solution which may be cast onto the thermoplastic substrate. The thermoplastic substrate may be in the form of a sheet. To prepare a support of PSU/PETP, the PSU and the PVP were mixed in a weight ratio of about 9:1 to obtain the support with desired chemical, mechanical, and thermal properties. Although the description herein refers to the use of PSU/PETP support, it may be understood by a person skilled in the art that other polymeric supports may be used as well, albeit with a few variations, as may be evident to a person skilled in the art. The support and corresponding layers may be prepared by any of the conventional methods known in the art—for example, the phase inversion method or the electrostatic spinning method. In a preferred embodiment, the PSU/PETP support is prepared by a modified phase inversion method. Phase inversion is a process in which membranes are fabricated. Phase inversion is performed by removing solvent from a liquid polymer solution, leaving a porous, solid membrane. Phase inversion may be carried out through reducing the temperature of the solution, immersing the polymer solution into an anti-solvent, exposing the polymer solution to a vapor of anti-solvent, evaporating the solvent in atmospheric air, evaporating the solvent at high temperature, and a combination thereof. A variation to a phase inversion process may be made in which a functional group-containing compound is added to a coagulation bath the support is in to incorporate the functional group-containing compound into the support. In an embodiment, the functional group-containing compound is an amine-containing compound, preferably a pentaamine. A mean pore diameter and pore diameter distribution may be varied and dependent on a rate at which phase inversion occurs.

The first layer of the membrane further includes pentaamine. The pentaamine in the first layer is physically adsorbed and/or dispersed in the polymer matrix and the PSU/PETP support. The pentaamine is physically adsorbed and/or dispersed in 0.5 to 5 μm, preferably 1 to 3 μm, of a top section of the first layer. The pentaamine is physically adsorbed and/or dispersed in the top section of the first layer which is contact with the second layer. In some embodiments, the pentaamine compound is a linear or branched aliphatic amine with 2-50 carbons and five amine groups. In a preferred embodiment, the pentaamine is tetraethylenepentamine. The first layer, including the polymer matrix and the pentaamine, is in the form of vertical hollow tubes having a diameter of 0.1 to 10 μm, preferably 0.2 to 5 μm, and more preferably about 0.5 to 2 μm, and a length of 1 to 50 μm, preferably 2 to 40 μm, and more preferably about 5 to 20 μm. The vertical hollow tubes comprising the polymeric matrix and the pentaamine may vary in diameter and length depending on synthesis materials and conditions towards varying applications. The vertical hollow tubes comprising the polymeric matrix and the pentaamine may vary in size, distribution, and regularity depending on synthesis materials and conditions towards varying applications. The thermoplastic substrate with the polysulfone and polyvinylpyrrolidone may be submerged in an aqueous amine solution comprising the pentaamine. In an embodiment, the thermoplastic substrate with the polysulfone and polyvinylpyrrolidone is submerged in an aqueous amine solution comprising the pentaamine for 1 to 12 hours, preferably 2 to 6 hours, and more preferably about 4 hours.

The membrane further includes a second layer that covers the vertical hollow tubes of the first layer. The second layer includes pentaamine and reacted units of a phthaloyl chloride cross-linked to form a polyamide. In a preferred embodiment, the phthaloyl chloride is terephthaloyl chloride (TCL). The pentaamine covalently cross-links with the TCL during the interfacial polymerization process to form a polyamide (PA). Interfacial polymerization is a step-growth polymerization in which the polymerization occurs at the interface between two immiscible phases (generally two liquids), and the resulting polymer is constrained to the interface, comprising the interfacial layer. Variations of interfacial polymerization include, but are not limited to, polymer topologies of ultrathin films, nanocapsules, nanofibers, and the like. Interfacial polymerization may be used to prepare polyamides, polyanilines, polyimides, polyurethanes, polyureas, polypyrroles, polyesters, polycarbonates, and the like. During the interfacial polymerization process of the present disclosure, at least one primary amine group of a first pentaamine and a secondary amine group of the first pentaamine, and at least one primary amine group of a second pentaamine and a secondary amine group of the second pentaamine are covalently crosslinked with terephthaloyl chloride to form a polyamide. In an embodiment, one or more primary amine groups of the first pentaamine may be covalently crosslinked with terephthaloyl chloride to one or more primary amine groups of the second pentaamine to form one or more polyamide linkages. In some embodiments, one or more primary amine groups of the first pentaamine may be covalently crosslinked with terephthaloyl chloride to one or more secondary amine groups of the second pentaamine to form one or more polyamide linkages. In an embodiment, one or more secondary amine groups of the first pentaamine may be covalently crosslinked with terephthaloyl chloride to one or more primary amine groups of the second pentaamine to form one or more polyamide linkages. In some embodiments, one or more secondary amine groups of the first pentaamine may be covalently crosslinked with terephthaloyl chloride to one or more secondary amine groups of the second pentaamine to form one or more polyamide linkages. In some embodiments, the first pentaamine and the second pentaamine(s) are covalently crosslinked with terephthaloyl chloride via a primary group and/or a secondary amine group of the first pentaamine and a primary group and/or a secondary amine group of the second pentaamine. The first pentaamine group and the second pentaamine group may be the same or different. In said embodiment, the first pentaamine and the second pentaamine is tetraethylenepentamine. The current disclosure may include one or more and any combination of the above disclosed polyamide linkages, as well as polyamide linkages not specifically disclosed herein.

In a preferred embodiment, one or more carbon atoms of the one or more acyl groups of a diacyl compound, such as a phthaloyl chloride, is covalently bonded to one or more nitrogen atoms of the pentaamines. In some embodiments, one or more carbon atoms of the one or more acyl groups of the diacyl compound may be covalently bonded to a primary amine group of the pentaamine. In some embodiments, one or more carbon atoms of the one or more acyl groups of the diacyl compound may be covalently bonded to a secondary amine group of the pentaamine. The pentaamine may be covalently bonded to one or more carbon atoms of the one or more acyl groups of the diacyl compound. The distribution and thickness of the active layer is variable and dependent on the choice of the method, reaction conditions, and the concentration of the pentaamine and the TCL. In some embodiments, the pentaamine in the second layer is covalently cross-linked with the reacted units of the phthaloyl chloride through at least one of a primary amine group and a secondary amine group of the first pentaamine, and at least one of a primary amine group and a secondary amine group of the second pentaamine to form the polyamide. The polyamide is a hyper-branched cross-linked matrix. The polyamide of the second layer may vary in thickness depending on synthesis materials and conditions towards varying applications. The second layer has a thickness of 0.1 to 10 μm, preferably 0.5 to 5 μm, and more preferably about 1 to 3 μm. The second layer is in the form of nanoparticles with a diameter of 10 to 500 nm, preferably 20 to 300 nm, and more preferably about 50 to 200 nm.

Surface roughness is another parameter determining the performance of the membrane. Literature reveals that rougher surfaces tend to foul because of the accumulation of foulants in the valleys, which reduces the permeate quality and flow rate. The membrane of the present disclosure has an average surface roughness of 24 to 27 nm, which is comparable to commercial membranes. The success of the fabrication process was determined based on the determining the water contact angle (WCA). Generally, if the WCA is smaller than 90°, the membrane is considered hydrophilic and if the WCA is larger than 90°, the membrane is considered hydrophobic. The WCA of the membrane of the present disclosure is in a range of 75° to 85°. The membrane has a rate of flux of methanol of 5 to 7 L m⁻² h⁻¹ at a pressure of 4 bar, and a rate of flux of methanol of 25 to 30 L m⁻² h⁻¹ at a pressure of 20 bar.

Elemental analysis reveals the successful fabrication of the membrane. The membrane includes carbon in an amount of 75 to 78%, preferably 76 to 77%, by weight, oxygen in an amount of 14 to 17%, preferably 15 to 16%, by weight, sulfur in an amount of 4 to 7%, preferably 5 to 6%, by weight, and nitrogen in an amount of 1 to 4%, preferably 2 to 3%, by weight based on the total weight of the membrane.

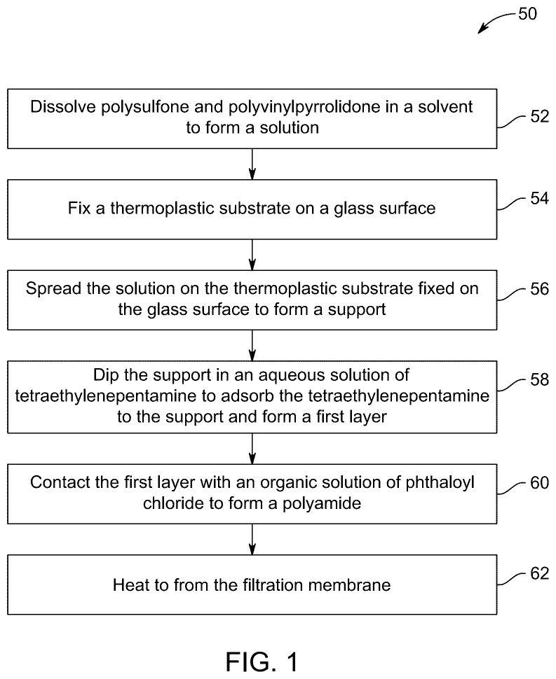

A method for making the membrane is described. Referring to FIG. 1, a schematic flow diagram of a method of making the membrane is illustrated. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes dissolving the polysulfone and the polyvinylpyrrolidone in a solvent to form a solution. Examples of polysulfones include PSU, PES, PPSU, PAS, PSF, or some derivative of polysulfone. The polysulfone polymer may also be called a polyaryl sulfone or a polyarylethersulfone. In a preferred embodiment, the polysulfone polymer is PSU. In some embodiments, other polymers such as polyvinyl chloride, polyvinylidene chloride, polyacrylonitrile, high impact polystyrene, acrylonitrile butadiene styrene, polyethylene/acrylonitrile butadiene styrene, polycarbonate/acrylonitrile butadiene styrene, acrylic polymers, polybutadiene, polyisoprene, polyacetylene, silicones, synthetic rubbers and the like, and copolymers and mixtures thereof may be used as well instead of polyvinylpyrrolidine. Optionally, other polymers such as, poly(vinylidene) fluoride, poly(tetrafluoroethylene), poly(acrylonitrile), poly(methyl methacrylate), poly(methacrylic acid), poly(acrylic acid), poly(vinyl methyl ketone), and poly(ethylene terephthalate), polysulfone, polyethersulfone, poly(ether sulfone), polypropylene, polyimide, and poly(arylene ether nitrile ketone), alone or in combination, may be used as well. In a preferred embodiment, the solvent is dimethylacetamide. The weight ratio of polysulfone to the polyvinylpyrrolidone is in a range of 1:1 to 20:1, preferably 3:1 to 18:1, preferably 5:1 to 15:1, preferably 7:1 to 12:1, preferably 9:1 to 11:1, and more preferably about 9:1. The weight ratio of polysulfone and polyvinylpyrrolidone to the solvent is in a range of 1:1 to 1:10, preferably 1:2 to 1:8, preferably 1:3 to 1:5, and more preferably about 1:4.

Optionally, copolymers may be used along with polyvinylpyrrolidone. Suitable examples of copolymers include vinylpyrrolidone/vinylacetate copolymers, vinylpyrrolidone/vinylalcohol copolymers, vinylpyrrolidone/styrene copolymers, vinylpyrrolidone/dimethylaminoethyl methacrylate copolymers, modified polymers thereof, or the like.

The polysulfone and the polyvinylpyrrolidone are dissolved in a solvent to form the solution. As used herein, the term “solvent” refers to and includes, but is not limited to, water (e.g. tap water, distilled water, deionized water, deionized distilled water), organic solvents, such as ethers (e.g. diethyl ether, tetrahydrofuran, 1,4-dioxane, tetrahydropyran, t-butyl methyl ether, cyclopentyl methyl ether, di-iso-propyl ether), glycol ethers (e.g. 1,2-dimethoxyethane, diglyme, triglyme), alcohols (e.g. methanol, ethanol, trifluoroethanol, n-propanol, iso-propanol, n-butanol, i-butanol, t-butanol, n-pentanol, i-pentanol, 2-methyl-2-butanol, 2-trifluoromethyl-2-propanol, 2,3-dimethyl-2-butanol, 3-pentanol, 3-methyl-3-pentanol, 2-methyl-3-pentanol, 2-methyl-2-pentanol, 2,3-dimethyl-3-pentanol, 3-ethyl-3-pentanol, 2-methyl-2-hexanol, 3-hexanol, cyclopropylmethanol, cyclopropanol, cyclobutanol, cyclopentanol, cyclohexanol), aromatic solvents (e.g. benzene, o-xylene, m-xylene, p-xylene, mixtures of xylenes, toluene, mesitylene, anisole, 1,2-dimethoxybenzene, α,α,α-trifluoromethylbenzene, fluorobenzene), chlorinated solvents (e.g. chlorobenzene, dichloromethane, 1,2-dichloroethane, 1,1-dichloroethane, chloroform), ester solvents (e.g. ethyl acetate, propyl acetate), amide solvents (e.g. dimethylformamide, dimethylacetamide, N-methyl-2-pyrrolidone, formamide, N-formylmorpholine, N-methylformamide, 2-pyrrolidone, tetramethylurea, N-vinylacetamide), urea solvents, ketones (e.g. acetone, butanone), acetonitrile, propionitrile, butyronitrile, benzonitrile, dimethyl sulfoxide, ethylene carbonate, propylene carbonate, 1,3-dimethyl-3,4,5,6-tetrahydro-2 (1H)-pyrimidinone, and mixtures thereof. As used herein, solvent may refer to non-polar solvents (e.g. hexane, benzene, toluene, diethyl ether, chloroform, 1,4-dioxane), polar aprotic solvents (e.g. ethyl acetate, tetrahydrofuran, dichloromethane, acetone, acetonitrile, dimethylformamide, dimethyl sulfoxide), polar protic solvents (e.g., acetic acid, n-butanol, isopropanol, n-propanol, ethanol, methanol, formic acid, water), and mixtures thereof. In one preferred embodiment, the solvent is an amide solvent. In a further embodiment, the solvent is dimethylacetamide, also written as N,N-dimethylacetamide. In one embodiment, the solvent is polar. In a preferred embodiment, the solvent is miscible with water.

The solution may be agitated for 0.5-3 hours, preferably 1-2 hours, and more preferably about 2 hours. The agitation may encompass shaking, stirring, rotating, vibrating, sonication, and other means of agitating the solution. The solution may be heated at a temperature of 30-90° C., 35-87° C., 40-85° C., or 50-80° C. for 0.5-12 hours, preferably 1-8 hours, preferably 2-6 hours, preferably 2-4 hours, and more preferably about 2 hours. The solution may be agitated throughout the duration of the reaction by employing a rotary shaker, a magnetic stirrer, a centrifugal mixer, or an overhead stirrer. Alternatively, the solution is left to stand (i.e., not agitated). The heating of the mixture may be carried out in a vacuum or under an inert gas such as N₂, Ar, and He. In a preferred embodiment, the solution is a homogenous mixture after agitation. In other embodiments, the solution may be a heterogenous mixture, suspension, and the like.

At step 54, the method 50 includes fixing the thermoplastic substrate on a glass surface. The thermoplastic substrate may be reinforced on a glass surface to impart greater mechanical/tensile strength to the membrane. In some embodiments, adhesives may be used to facilitate the fixing of the thermoplastic substrate to the glass surface. In an embodiment, the adhesive is a polyurethane adhesive. In certain other embodiments, the glass surface may optionally be surface activated by any of the methods conventionally known in the art, to facilitate the attachment of the thermoplastic substrate to the glass surface.

At step 56, the method 50 includes spreading the solution on the thermoplastic substrate fixed on the glass surface to form a support. The solution is uniformly spread on the thermoplastic substrate using methods known in the art. The solution may be spread using a doctor's blade or any other tools known in the art. The doctor's blade may have a slit size of 50 to 500 μm, preferably 100 to 200 μm, and more preferably about 100 μm.

At step 58, the method 50 includes dipping the support in an aqueous solution of the tetraethylenepentamine to adsorb the tetraethylenepentamine to the support and form a first layer. The support was dipped in the aqueous solution for a period of 1-6 hours, preferably 2-5 hours, more preferably 3-4 hours, and yet more preferably about 4 hours, with intermittent or constant shaking, to form the first layer.

At step 60, the method 50 includes contacting the first layer with an organic solution of the phthaloyl chloride to form the polyamide. In an embodiment, the phthaloyl chloride is terepthaloyl chloride (TCL). The TCL was dissolved in n-hexane to form the organic solution. The concentration of TCL in the n-hexane is in a range of 0.1-1, preferably 0.1-0.5, and more preferably 0.1-0.2 wt/v %. During this process, an IP reaction occurs where the pentaamine is covalently cross-linked with units of the phthaloyl chloride through at least one of a primary amine group and a secondary amine group of a first pentaamine and at least one of a primary amine group and a secondary amine group of a second pentaamine to form a polyamide. The polyamide is a hyper-branched cross-linked matrix. One of the factors that affect the performance of the membrane is the duration to which the complex is exposed to the cross-linker. In an embodiment, the complex may be dipped in the cross-linker solution for 1-5 minutes, preferably 1-3 minutes, more preferably about 1 minute to form the membrane. The excess hexane may then be washed to remove solvent or impurities, to form the polyamide.

At step 62, the method 50 includes heating to form the filtration membrane. The polyamide is further heated in an oven for a period of 0.5-3 hours, preferably 60-90 minutes, and more preferably about 60 minutes at a temperature range of 60-100° C., preferably 70-90° C., and more preferably about 80° C., to evaporate the solvents (n-hexane), resulting in the formation of the membrane.

Another aspect of the present disclosure describes a method of nanofiltration with the filtration membrane of the present disclosure. The method includes passing a composition through the filtration membrane. The method may optionally include wetting the filtration membrane with a solvent before passing the composition through the filtration membrane. The composition includes solvents and solutes. The solvents are water, methanol, ethanol, and isopropanol. The solute may be a dye. Suitable examples of dyes include, alkaline methylene blue, methylene blue, tetrazine, acid orange, phenolic phenol, bisphenol, 2,4 dichlorophenol, Congo red, toluene, chromium ions, bromate ions, eosin yellow, Eriochrome black T (EBT), and the like. On passing the composition through the membrane, the membrane selectively allows for the passage of the solvents leaving behind the solutes. The separation may be based on size-exclusion phenomena. The method further includes collecting a permeate passing through the filtration membrane to obtain a purified composition having a reduced amount of solutes. Composition refers to a solution containing unwanted substances or impurities, or pollutants, or otherwise refers to a solution that affects the physical body, workplace, environment, or any experimental procedure. The composition includes a solvent and a pollutant. The pollutant may be a pharmaceutically active compound, dye, ionic salts, or a combination thereof. In some embodiments, the membrane has a rejection profile of solutes from 85 to 100% by weight in methanol. In an embodiment, when the solvent is methanol, the solute is Congo red, and the membrane has a rejection profile from 95 to 100% by weight.

### Examples

The following examples demonstrate the filtration membrane as described herein. The examples are provided solely for illustration and are not to be construed as limitations of the present disclosure, as many variations thereof are possible without departing from the spirit and scope of the present disclosure.

### Materials and Methods

Polysulfone (PSU) beads, polyvinylpyrrolidone (PVP) powder, pentaamine (tetraethylenepentamine: TEPA), terephthaloyl chloride (TCL), triethylamine (TEA) dimethylacetamide (DMAc), Congo red (CR) dye, Erichrome Black T (EBT) dye, and methylene blue (MB) dye were purchased from Sigma (USA). Other solvents, such as n-hexane, methanol, ethanol, and isopropanol, were purchased from Fisher Scientific (USA). Fabrication of PA (TEPA-TCL)@PSU/PETP membrane

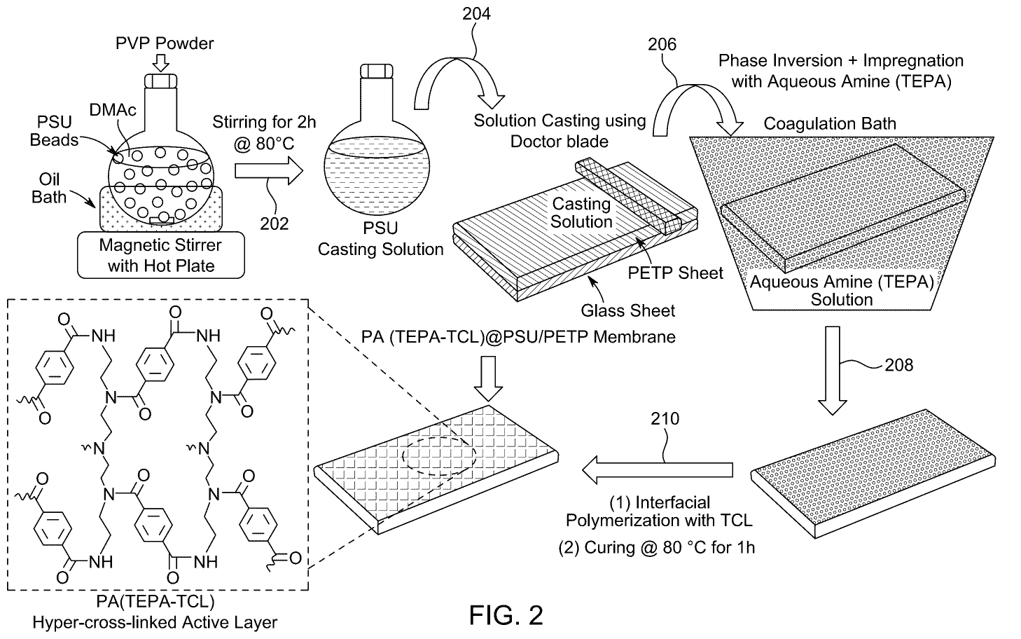

The PA (TEPA-TCL)@PSU/PETP membrane was fabricated by using a relatively rapid method compared to the conventional approach of fabricating TFC membranes, as shown in FIG. 2. The polysulfone (PSU) dope solution was prepared by adding 18.0 g of PSU and 2.0 g of polyvinylpyrrolidone (PVP) in 80.0 g of DMAc. The above mixture was stirred at 80° C. for 2 hours, leading to the dissolution of PSU beads, and the resultant dope solution was allowed to stand at room temperature until all of the entrapped air bubbles escaped from the dope solution (202). Afterward, an appropriately sized piece of unwoven polyester terephthalate (PETP) was fixed on a perfectly flat glass surface, and a thin film of PSU dope solution was spread on PETP by using a doctor's blade (100 μm slit size) (204). Then a modified process of phase inversion was carried out where tetraethylenepentamine (TEPA) was added to the DI water coagulation bath. The phase inversion in the TEPA-containing water bath resulted in thoroughly incorporating TEPA in PSU/PETP support (206). To ensure comprehensive wetting of PSU/PETP support with TEPA, the PSU/PETP support was allowed to sit in the TEPA solution bath for 4 hours. Afterwards, the TEPA-impregnated PSU/PETP support was removed from the TEPA bath and excess TEPA solution was removed by using a rubber roller (208). The TEPA-loaded PSU/PETP support was dipped in TCL solution (0.15% in n-hexane) for 1 minute leading to the establishment of a polyamide (PA) active layer (210). The membrane was cured at 80° C. for 1 hour. The active layer was established from within the PSU/PETP support and covered the PSU/PETP support, leading to the establishment of PA (TEPA-TCL)@PSU/PETP membrane. The stages of fabrication of PA (TEPA-TCL)@PSU/PETP membrane are given in FIG. 2.

### Characterization of PA (TEPA-TCL)@PSU/PETP Membrane

Following the fabrication of the PA (TEPA-TCL)@PSU/PETP membrane, a comprehensive characterization was carried out. ATR-FTIR (Nicolet™ iS50, Thermo Fisher Scientific, Waltham, Massachusetts, United States) was used to determine the functional groups present in PA (TEPA-TCL)@PSU/PETP membrane. For the sake of ATR-FTIR, a dried piece of PA (TEPA-TCL)@PSU/PETP was taken and fixed in ATR mode for running the FTIR experiment. Surface hydrophilicity was determined by measuring the water contact angle (WCA) of the membranes. In order to determine the WCA of PA (TEPA-TCL)@PSU/PETP membrane, a dried piece of PA (TEPA-TCL)@PSU/PETP membrane was taken and fixed onto a glass slide before measuring WCA by goniometer (DSA 20, KRUSS GmbH, Borsteler Chaussee 85, 22453 Hamburg, Germany). Surface morphology was investigated by running field emission scanning electron microscopy (FESEM) (Quattro FESEM, Thermo Fisher, Waltham, Massachusetts, United States) on an appropriately selected piece of PA (TEPA-TCL)@PSU/PETP membrane, which was coated with gold prior to FESEM analysis. Elemental composition and distribution in the membrane active layer were studied by using FESEM coupled energy dispersive X-ray (EDX) analysis and elemental mapping, respectively [A. Waheed, U. Baig, I. H. Aljundi, Fabrication of molecularly porous hyper-cross-linked thin film composite nanofiltration membrane using cyclic amine and linear cross-linker for highly selective organic solvent nanofiltration, Colloid Interface Sci Commun. 45 (2021) 100530; and A. Waheed, S. Abduljawad, U. Baig, Design and fabrication of polyamine nanofiltration membrane by constituting multifunctional aliphatic linear amine and trifunctional cyanuric chloride for selective organic solvent nanofiltration, J Taiwan Inst Chem Eng. 131 (2022) 104204, both of which are incorporated herein by reference in their entirety].

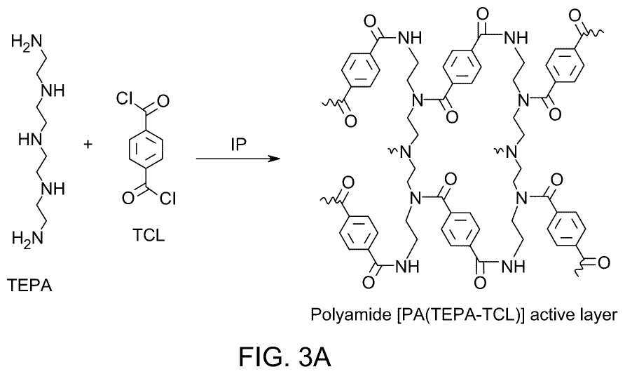

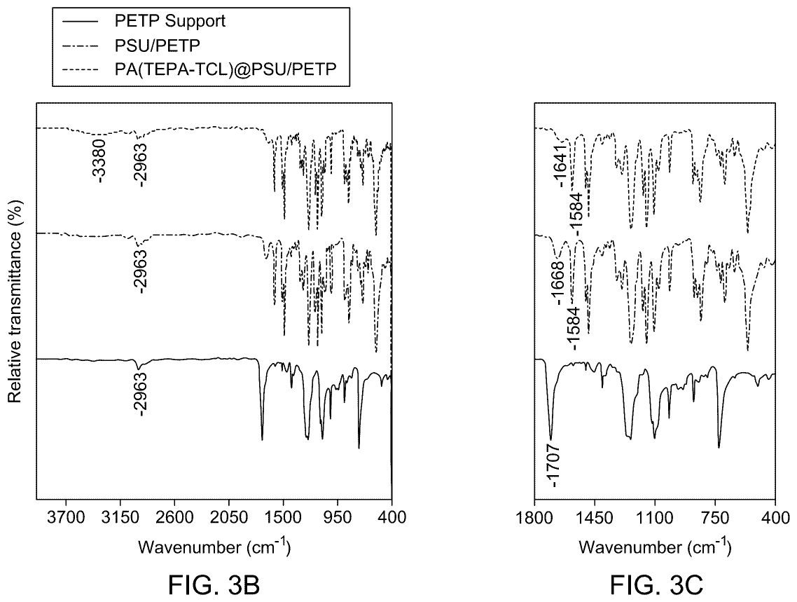

Following characterization, the PA (TEPA-TCL)@PSU/PETP membrane was tested for its potential for organic solvent nanofiltration (OSN) performance. During OSN performance tests, a flux of a variety of organic solvents, such as methanol, ethanol, and isopropanol, was measured using a dead-end filtration cell by using Equation 1:

$$J = \frac{V}{A \times t} \qquad ( 1 )$$

where J is flux (LMH: L m⁻² h⁻¹), V is volume (L) of the permeate collected in a given time, A is area (m²) of the membrane which is involved in the separation, and t is time (h) recorded during the permeation of certain volume of permeate through the membrane. The rejection of various dyes, such as CR, EBT, and MB, was studied by using Equation 2:

$$R = ( 1 - \frac{{C}_{p}}{{C}_{f}} ) \times 100 \qquad ( 2 )$$

where R is rejection, and C_{f} and Cₚ are the concentrations of dyes in the feed and permeate, respectively. The concentration of dyes in the feed and permeate were measured by UV-Visible spectroscopy. The PA (TEPA-TCL)@PSU/PETP membrane was fabricated using a rapid approach. Conventionally, ultrafiltration PSU/PETP support is either purchased or self-fabricated through phase inversion. In either case, the PSU/PETP support is dipped in distilled (DI) water overnight, followed by another round of dipping the same PSU/PETP support in the SDS solution, which increases membrane wettability [M. G. Elshof, E. Maaskant, M. A. Hempenius, N. E. Benes, Poly(aryl cyanurate)-Based Thin-Film Composite Nanofiltration Membranes, ACS Appl Polym Mater. 3 (2021) 2385-2392, incorporated herein by reference in its entirety]. After about 48 hours of wetting, the PSU/PETP support is dipped in aqueous amine solution leading to amine impregnation of the PSU/PETP support. In the current approach, both phase inversion and amine (TEPA) impregnation were combined together, resulting in thorough incorporation of TEPA into PSU/PETP support. Hence, this method not only reduced the effort and time needed for membrane fabrication but also gave an opportunity for the complete impregnation of TEPA into the matrix of the PSU/PETP support. Upon impregnatation with TEPA, the PSU/PETP support was exposed to a TCL solution for the sake of completion of IP. As TCL is an efficient cross-linker, a polyamide (PA) active layer is grown from within the PSU/PETP support to the top leading to a TFC membrane. The membrane was cured at 80° C. to enhance the polymerization reaction between TEPA and TCL, resulting in PA (TEPA-TCL)@PSU/PETP membrane. A proposed structure of an active layer of PA (TEPA-TCL)@PSU/PETP membrane is given in FIG. 3A.

The ATR-FTIR spectra of PETP, PSU/PETP support, and PA (TEPA-TCL)@PSU/PETP membrane are given in FIG. 3B and FIG. 3C. The FTIR spectrum of PA (TEPA-TCL)@PSU/PETP membrane showed evidence of aromatic ═C—H bond stretching at peaks spanning in the region of 3000 cm⁻¹. PETP is an ester and a characteristic peak of >C═O was found at around 1700 cm⁻¹. Similar peaks were found in PSU/PETP support. An additional peak was found at around 1600 cm⁻¹ in the PSU/PETP support and the PA (TEPA-TCL)@PSU/PETP membrane, which was due to the S═O group of PSU. In the case of PA (TEPA-TCL)@PSU/PETP membrane, an additional characteristic peak was found in the region from 3200 cm⁻¹ to 3500 cm⁻¹, which was attributed to amide bond (—CONH—) [M. Mondal, H. D. Raval, Removal of arsenic from water using a novel polyamide composite hollow fiber membrane by interfacial polymerization on lumen side, J Environ Chem Eng. 10 (2022) 107843; and U. Baig, S. M. S. Jillani, A. Waheed, M. A. Ansari, Exploring a combination of unconventional monomers for fabricating a hyper-cross-linked polyamide membrane with anti-fouling properties for the production of clean water, Process Safety, and Environmental Protection. 165 (2022) 496-504, which are both incorporated herein by reference in their entirety]. An amide bond is formed by the reaction of TEPA and TCL, which leads to the formation of a polyamide active layer.

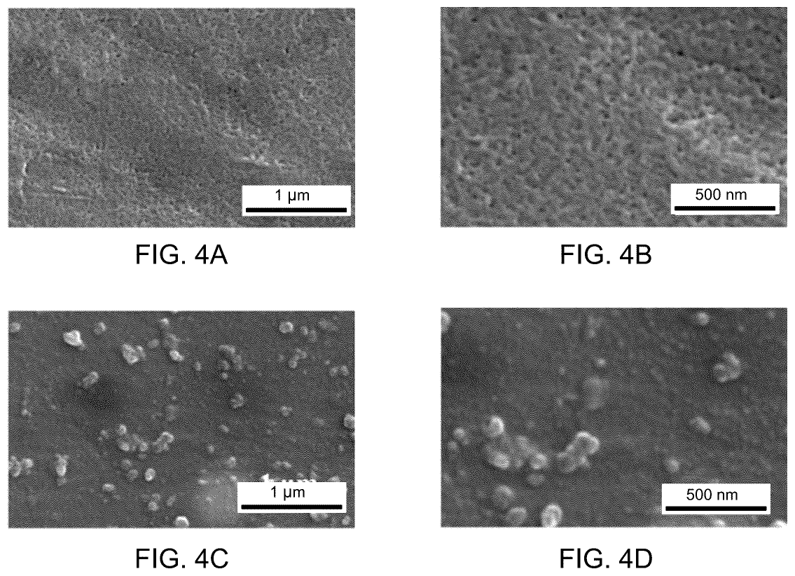

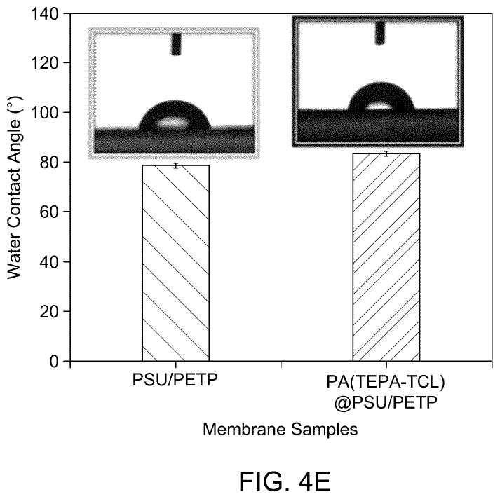

The surface morphological features help in understanding the functioning of the polyamide membrane during filtration experiments. FIGS. 4A-4B represent FESEM micrographs of PSU/PETP (FIG. 4A and FIG. 4B), while the micrographs of PA (TEPA-TCL)@PSU/PETP membrane are given in FIG. 4C and FIG. 4D. In the case of the PSU/PETP support, the surface appears smooth with uniformly distributed micropores. The micropores are generated during phase inversion, where a solvent such as DMAc is replaced by a non-solvent such as water. In the present disclosure, a modified phase inversion was carried out by adding TEPA in a coagulation bath, where the micropores of the membrane are impregnated with TEPA. In the case of the PA (TEPA-TCL)@PSU/PETP membrane, the micropores of PSU/PETP were not visible at 500 nm, which can be attributed to the successful IP reaction between TEPA and TCL. The reaction between TEPA and TCL led to the formation of a continuous polyamide active layer which led to the covering of the pores of the membrane. Moreover, the formation of the globules on the membrane surface is also a confirmation of extensive crosslinking between TEPA and TCL. A continuous and crack-free active layer is used for the normal functioning of polyamide membranes. Another feature is the surface hydrophilicity of the membrane, which is measured by the water contact angle (WCA), as shown in FIG. 4E. The WCA of PA (TEPA-TCL)@PSU/PETP membrane (81°) was found to be more than PSU/PETP, which has a WCA of 78°. Both WCAs were less than 90°, and hence the membranes were found to be hydrophilic in nature [R. Pang, K. Zhang, High-flux polyamide reverse osmosis membranes by surface grafting 4-(2-hydroxyethyl) morpholine, RSC Adv. 7 (2017) 40705-40710, incorporated herein by reference in its entirety].

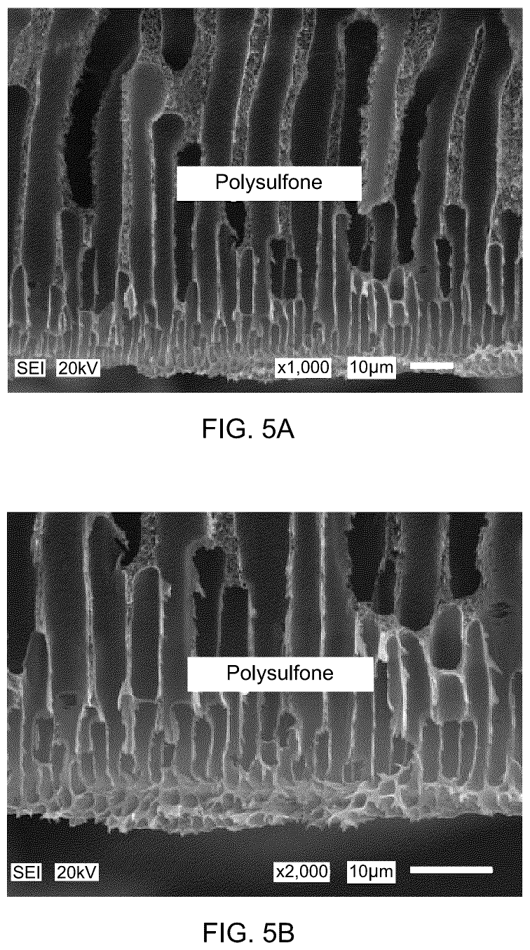

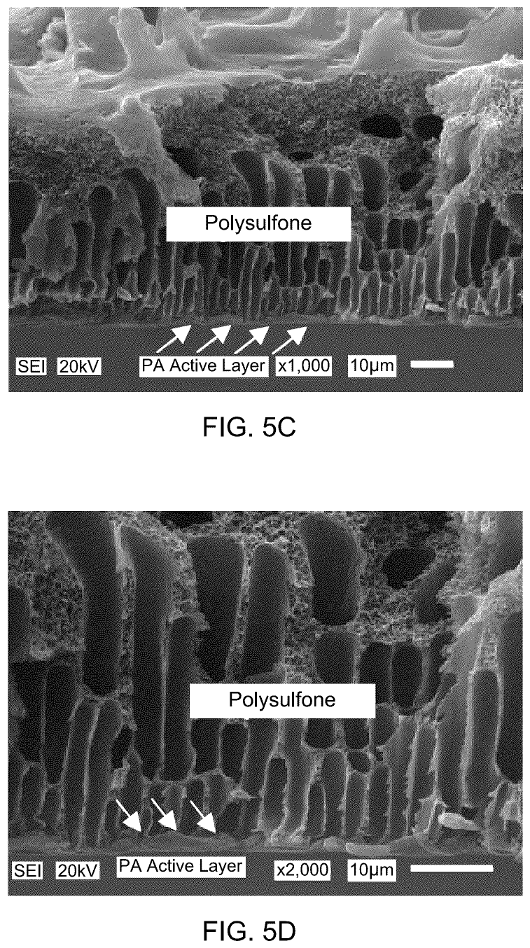

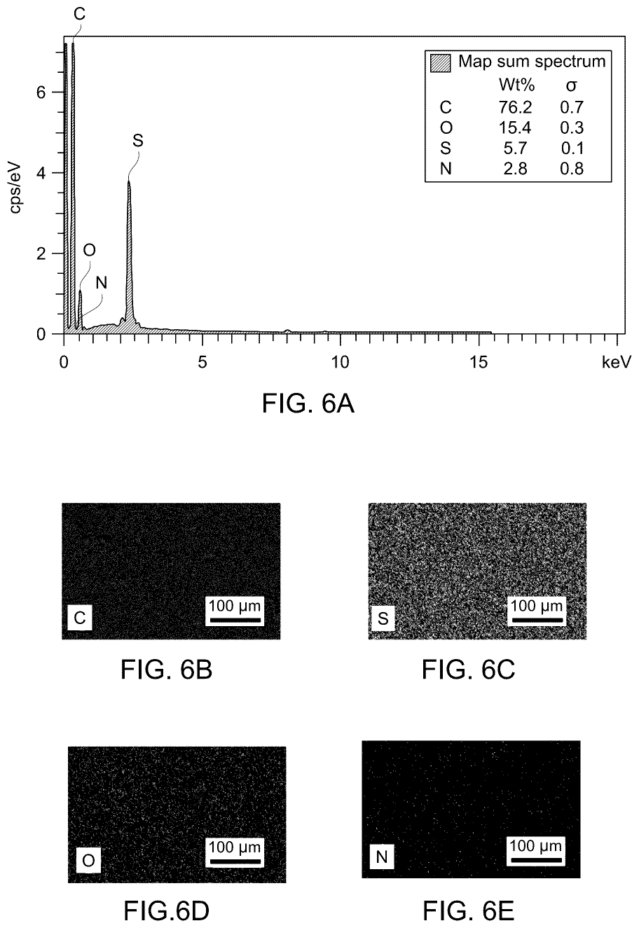

In order to get further insight into the structural morphology of the fabricated membrane, the cross-sectional micrographs of the PSU/PETP support and PA (TEPA-TCL)@PSU/PETP membrane are given in FIG. 5. The cross-sectional analysis of the PSU/PETP support (FIG. 5A and FIG. 5B) indicated the presence of several finger-like projections in the PSU matrix which are generated during wet phase inversion. The existence of such channels and canals provide a free passage to the permeating pure water with minimum resistance. However, in the case of PA (TEPA-TCL)@PSU/PETP membrane, a thin polyamide selective layer can be seen on the top of the PSU/PETP support (FIG. 5C and FIG. 5D). The presence of thin polyamide assists in the membrane separation process. A thin selective polyamide layer is generated on the PSU/PETP during the IP reaction between TEPA and TCL. An analysis of the surface elemental composition of the PA (TEPA-TCL)@PSU/PETP membrane revealed the presence of carbon (C), oxygen (O), sulfur(S), and nitrogen (N) (FIG. 6A). These elements originated from various polymers involved in membrane fabrication: for example, C and O are present in each of the participating polymers such as PSU and the polyamide. The presence of S can be justified as a constituent element of PSU, while N is attributed to the polyamide active layer. Elemental mapping data showed a uniform distribution of each of the above-mentioned elements in the membrane (FIG. 6B-FIG. 6E). Moreover, the intensity of the colors represents the relative concentration of the different elements in the active layer of the membrane. The high intensity of C is due to a higher percentage (76.2%) of C in the active layer of the membrane (FIG. 6B). The intensity of the N is lower compared to other elements (FIG. 6E), such as O (FIG. 6D), S (FIG. 6C), and C (FIG. 6B), which is due to the low concentration (2.8%) of N in the active layer. The concentration of an element in the active layer is directly dependent on the amount of element shown in the mapping images.

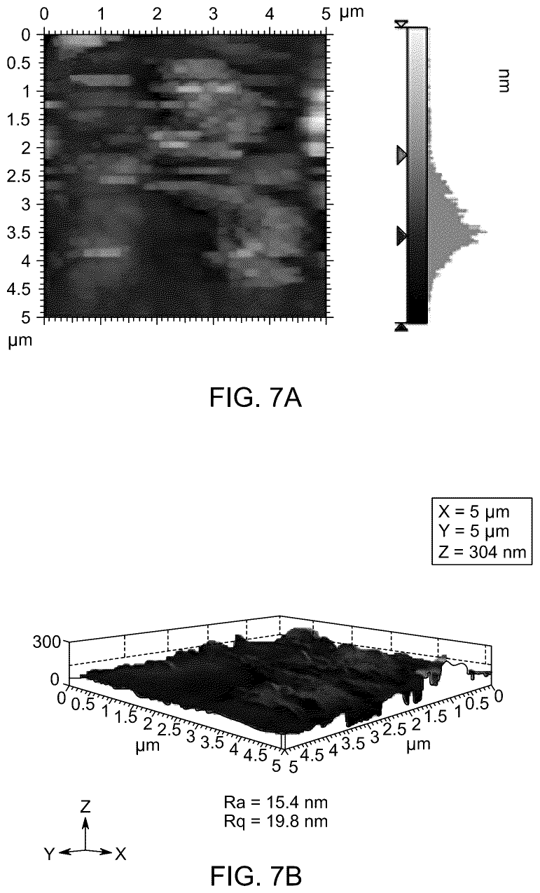

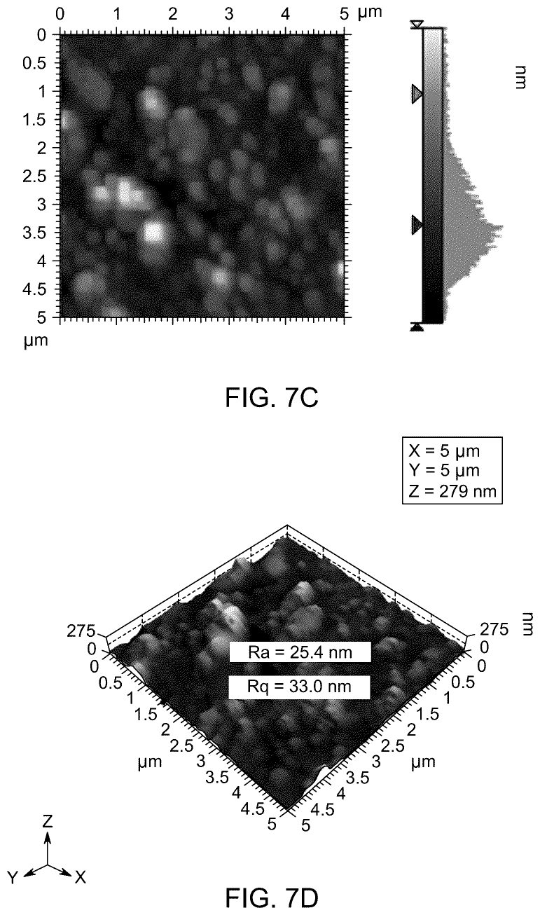

The surface topologies of the PSU/PETP support and PA (TEPA-TCL)@PSU/PETP membrane are given in FIG. 7. The surface of PSU/PETP support showed an average surface roughness (Rₐ) of 15.4 nm (FIG. 7B), which is attributed to a relatively smooth layer of PSU on PETP shown in FIG. 7A and FIG. 7B. In the case of PA (TEPA-TCL)@PSU/PETP membrane (FIG. 7C and FIG. 7D), the average surface (Rₐ) is enhanced (25.4 nm) after the growth of the polyamide active layer on PSU/PETP support. The roughness increases due to the establishment of polyamide globules and crosslinked networks on the PSU/PETP support.

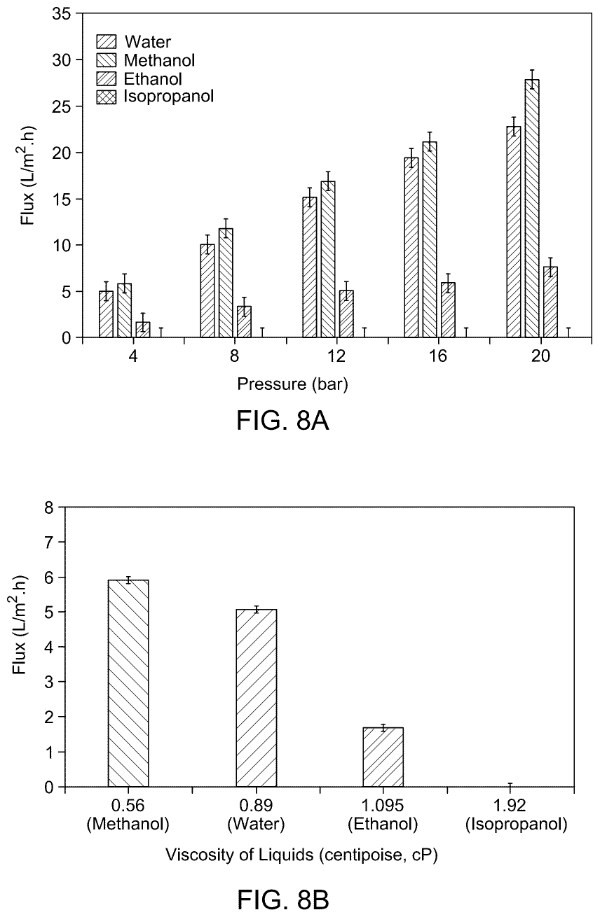

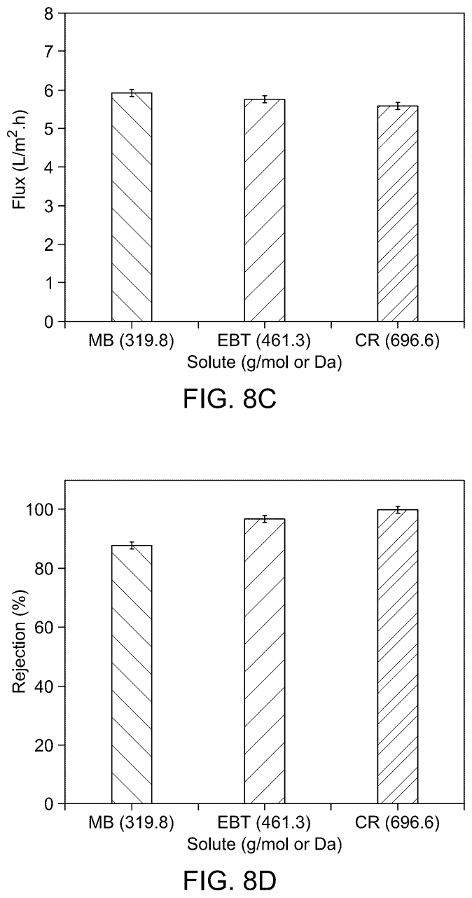

For organic solvent nanofiltration (OSN) performance evaluation of the PA (TEPA-TCL)@PSU/PETP membrane, various organic solvents(methanol, ethanol, and isopropanol) and water were used as feed. Three differently-sized organic dyes (MB, EBT, and CR) were used as solutes. The effect of transmembrane pressure on permeate flux was studied, as shown in FIG. 8A. As the transmembrane pressure increased, an increase in permeate flux was observed. From among the various solvents, methanol showed the highest permeate flux of 28 LMH, followed by water (22 LMH), while the lowest flux (7 LMH) was observed for ethanol at 20 bar. Isopropanol was not permeated even at 20 bar of applied transmembrane pressure. These findings were supported by considering the viscosity of the tested solvents. The permeate flux decreased with increasing viscosity of solvents [A. Waheed, U. Baig, I. H. Aljundi, Fabrication of molecularly porous hyper-cross-linked thin film composite nanofiltration membrane using cyclic amine and linear cross-linker for highly selective organic solvent nanofiltration, Colloid Interface Sci Commun. 45 (2021); and T. Huang, B. A. Moosa, P. Hoang, J. Liu, S. Chisca, G. Zhang, M. AlYami, N. M. Khashab, S. P. Nunes, Molecularly-porous ultrathin membranes for highly selective organic solvent nanofiltration, Nature Communications 2020 11:1. 11 (2020) 1-10, both of which are incorporated herein by reference in their entirety], as shown in FIG. 8B. Methanol has the lowest viscosity of 0.56 cP and the highest flux of 22 LMH, while isopropanol has the highest viscosity of 1.92 cP with no permeate at a pressure of 20 bar.

After studying the permeance of various solvents through PA (TEPA-TCL)@PSU/PETP membrane, variation of permeate flux and rejection of differently sized dyes was also studied where methanol was used as a solvent. It was observed that with an increase in the molecular weight of dyes, the permeate flux was decreased (FIG. 8C). This might be attributed to the entrapment of bigger dye molecules in the channels of the membrane leading to the lowering of permeate flux. The highest methanol flux, 6 LMH, was observed in the case of MB, while the lowest permeate flux of 5.5 LMH, was observed for CR. Rejection of dyes increased with increasing molecular weight of the dyes as rejection of EBT (461.3 g mol⁻¹) and CR (M.W.=696.6 g mol⁻¹) reached >92% and >96%, respectively, while it stayed at ≈88% for MB (319.8 g mol⁻¹) (FIG. 8D). Apparently, the rejection follows size exclusion principle as the size increases the rejection of dyes also increases.

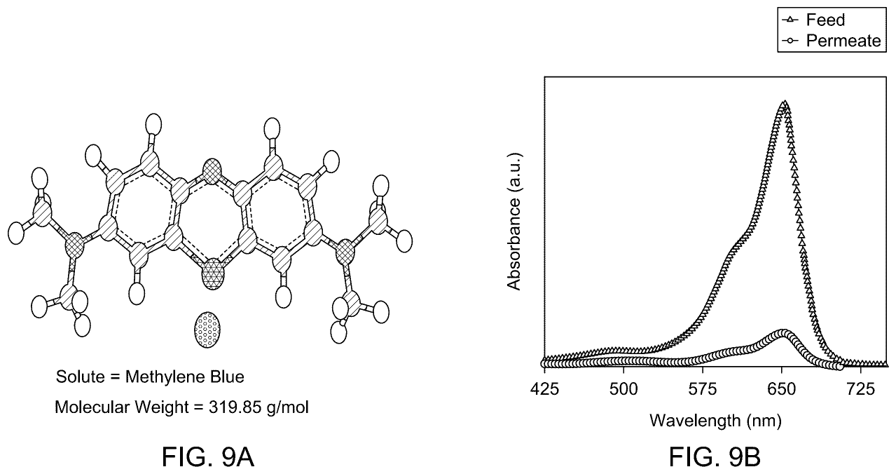

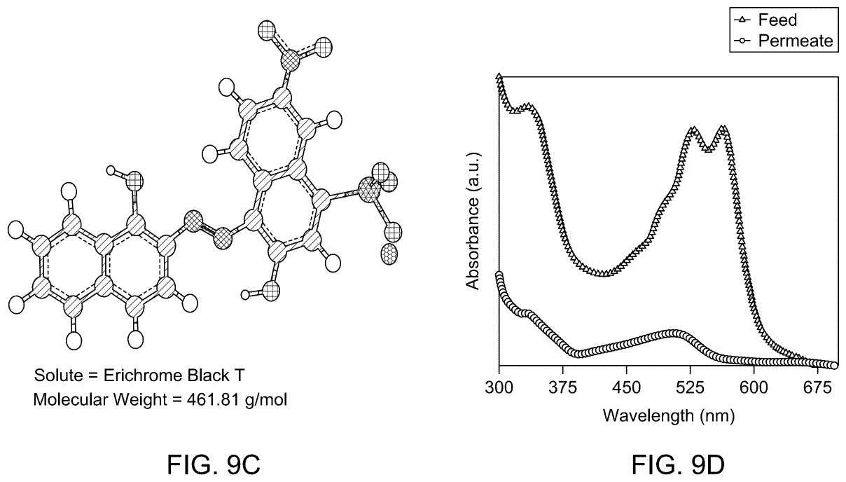

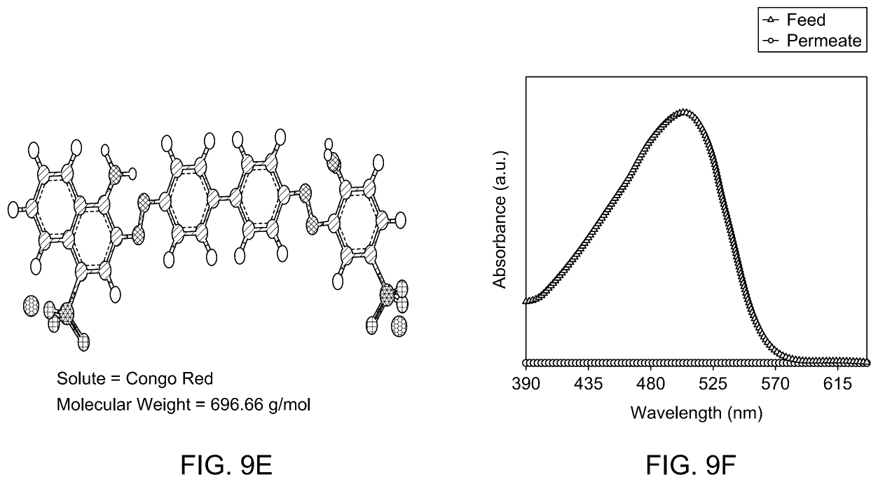

The absorption spectra of feeds and permeates were measured, as shown in FIG. 9. The 3D structures of all of the tested dyes, MB, EBT, and CR, are shown in FIGS. 9A, 9C, and 9E, respectively. The corresponding absorption spectra of MB, EBT, and CR are given in FIGS. 9B, 9D, and 9F, respectively. The absorption of light by the permeates has decreased compared to the absorption of light by feeds. In the case of CR, there is no light absorption by the permeate, which indicate the nearly complete rejection of CR from the feed.

TABLE 1
A comparison of PA(TEPA-TCL)@PSU/PETP membrane
with the OSN membranes from the literature.

| | | | Solute and | | |
|---|---|---|---|---|---|
| | | | Molecular | | |
| | | Flux | weight | Rejection | |
| Membrane | Solvent | (Lm⁻²h⁻¹) | (g mol⁻¹) | (%) | Ref. |
| Molecularly | Methanol | 4.5 | CR (696.55) | >94 | [28] |
| porous | | | EBT (461.81) | >72 | |
| hyper-cross- | | | MB (319.85) | >90 | |
| linked | | | | | |
| polyamide | | | | | |
| TFC-NF | | | | | |
| membrane | | | | | |
| PA@PS/PET | Methanol | 3.69 | CR (696.55) | >95 | [29] |
| TFC-NF | | | EBT (461.81) | >96 | |
| membrane | | | MB (319.85) | >67 | |
| Polybenzimidazole | | | | | [38] |
| (PBI) | | | | | |
| membranes | | | | | |
| PBI | Ethanol | ~3.0 | CR (696.55) | >60 | |
| PBX | Ethanol | ~2.0 | CR (696.55) | >75 | |
| PCX | Ethanol | ~2.5 | CR (696.55) | >70 | |
| PMC | Ethanol | ~3.2 | CR (696.55) | >70 | |
| PBC | Ethanol | ~1.8 | CR (696.55) | >65 | |
| PCS | Ethanol | ~1.9 | CR (696.55) | >70 | |
| PMS | Ethanol | ~2.0 | CR (696.55) | >70 | |
| PA(TEPA- | Methanol | 6 | CR (696.55) | 99.91 | This Work |
| TCL)@PSU/ | | | EBT (461.81) | 96.92 | |
| PETP | | | MB (319.85) | 87.85 | |
| membrane | | | | | |

Reference [28] corresponds to A. Waheed, U. Baig, I. H. Aljundi, Fabrication of molecularly porous hyper-cross-linked thin film composite nanofiltration membrane using cyclic amine and linear cross-linker for highly selective organic solvent nanofiltration, Colloid Interface Sci Commun. 45 (2021) 100530; reference corresponds to A. Waheed, S. Abduljawad, U. Baig, Design and fabrication of polyamine nanofiltration membrane by constituting multifunctional aliphatic linear amine and trifunctional cyanuric chloride for selective organic solvent nanofiltration, J Taiwan Inst Chem Eng. 131 (2022) 104204; reference corresponds to S. S. Beshahwored, Y.-H. Huang, Z. G. Abdi, C.-C. Hu, T.-S. Chung, Polybenzimidazole (PBI) membranes cross-linked with various cross-linkers and impregnated with 4-sulfocalix [4] arene (SCA4) for organic solvent nanofiltration (OSN), J Memb Sci. 663 (2022) 121039, each of which are incorporated by reference in their entirety.

To summarize, a polyamide PA (TEPA-TCL)@PSU/PETP membrane was fabricated using rapid interfacial polymerization. An amine, TEPA, was dissolved in a coagulation bath and phase inversion was carried out in the presence of TEPA. This technique proved to be advantageous in conserving extra steps and yielding highly dense PA (TEPA-TCL)@PSU/PETP. The AFM showed an increase in average roughness (Rₐ) of PA (TEPA-TCL)@PSU/PETP membrane (Rₐ=25.4 nm) compared to PSU/PETP support (Rₐ=15.4 nm). The fabricated PA (TEPA-TCL)@PSU/PETP membrane could permeate organic and inorganic solvents, including water, methanol, and ethanol. The membrane also rejected a variety of organic solutes such as MB, EBT, and CR. The rejection reached >96% for CR when methanol was used as a solvent for the feed. Moreover, PA (TEPA-TCL)@PSU/PETP membrane was able to achieve a methanol flux of 28 LMH at 20 bar. The pure solvent flux was found to be dependent upon applied transmembrane pressure and solvent viscosity. A direct relationship was found between pure solvent flux and applied transmembrane pressure, while solvent viscosity showed an inverse relationship to pure solvent flux. Methanol has the lowest viscosity of 0.56 cP and the highest flux of 22 LMH, while isopropanol has the highest viscosity of 1.92 cP with no permeate at 20 bar.

Numerous modifications and variations of the present invention are possible in light of the above teachings. It is, therefore, to be understood that, within the scope of the appended claims, the invention may be practiced otherwise than as specifically described herein.

1: A filtration membrane, comprising, in the following order:
a thermoplastic substrate,
a first layer comprising a polysulfone, a polyvinylpyrrolidone, and a pentaamine,
a second layer comprising the pentaamine and reacted units of a phthaloyl chloride cross-linked to form a polyamide.

2: The filtration membrane of claim 1, wherein the pentaamine in the first layer is physically adsorbed and/or dispersed in the polysulfone and the polyvinylpyrrolidone.

3: The filtration membrane of claim 1, wherein the pentaamine in the second layer is covalently cross-linked with units of the phthaloyl chloride through at least one of a primary amine group and a secondary amine group of a first pentaamine and at least one of a primary amine group and a secondary amine group of a second pentaamine.

4: The filtration membrane of claim 1, wherein the second layer comprises the polyamide in a hyper-branched cross-linked matrix.

5: The filtration membrane of claim 1, wherein the pentaamine is a tetraethylenepentamine.

6: The filtration membrane of claim 1, wherein the second layer is in the form of nanoparticles with a diameter of 10 to 500 nm.

7: The filtration membrane of claim 1, wherein the first layer is in the form of vertical hollow tubes having a diameter of 0.5 to 10 μm and a length of 5 to 50 μm.

8: The filtration membrane of claim 7, wherein the second layer covers the vertical hollow tubes of the first layer.

9: The filtration membrane of claim 1, wherein the second layer has a thickness of 0.5 to 5 μm.

10: The filtration membrane of claim 1, wherein a water contact angle is from 75 to 85°.

11: The filtration membrane of claim 1, comprising carbon in an amount of 75 to 78% by weight, oxygen in an amount of 14 to 17% by weight, sulfur in an amount of 4 to 7% by weight, and nitrogen in an amount of 1 to 4% by weight based on a total weight of the membrane.

12: The filtration membrane of claim 1, wherein a surface roughness is from 24 to 27 nm.

13: The filtration membrane of claim 1 made by a process, comprising:
dissolving the polysulfone and the polyvinylpyrrolidone in a solvent to form a solution;
fixing the thermoplastic substrate on a glass surface;
spreading the solution on the thermoplastic substrate fixed on the glass surface to form a support;
dipping the support in an aqueous solution of the tetraethylenepentamine to adsorb the tetraethylenepentamine to the support and form the first layer;
contacting the first layer with an organic solution of the phthaloyl chloride to form the polyamide; and
heating to from the filtration membrane.

14: The filtration membrane of claim 1, wherein the membrane has a rate of flux of methanol of 5 to 7 L m⁻² h⁻¹ at a pressure of 4 bar.

15: The filtration membrane of claim 1, wherein the membrane has a rate of flux of methanol of 25 to 30 L m⁻² h⁻¹ at a pressure of 20 bar.

16: A method of nanofiltration, comprising:
passing a composition through the filtration membrane of claim 1,
wherein the composition comprises at least solvents and solutes,
collecting a permeate passing through the filtration membrane to obtain a purified composition having a reduced amount of solutes.

17: The filtration membrane of claim 1, wherein the membrane has a rejection profile of solutes from 85 to 100% by weight in methanol.

18: The filtration membrane of claim 17, wherein the solutes are Congo Red, Eriochrome Black T, and Methylene Blue.

19: The method of claim 16, wherein the solvents are water, methanol, ethanol, and isopropanol.

20: The method of claim 16, wherein the solvent is methanol, the solute is Congo Red, and the membrane has a rejection profile from 95 to 100% by weight.
